(19) United States
(12) Patent Application Publication
(10) Pub. No.: US 2010/0179838 A1
(43) Pub. Date: Jul. 15, 2010

(54) HEALTHCARE SERVICE PROVIDER INSURANCE CLAIM FRAUD AND ERROR DETECTION USING CO-OCCURRENCE

(76) Inventors: Nitin Basant, Ramgarh Cant (IN); Moiz Saifee, Ujjain (IN); Shafi Rahman, Bangalore (IN); Michael Tyler, San Diego, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/354,431

(22) Filed: Jan. 15, 2009

(51) Int. Cl. G06Q 40/00

(52) U.S. Cl. 705/4

(57) ABSTRACT

Data characterizing one or more healthcare insurance claims is received. Each claim comprises variables characterizing aspects of a healthcare service for which reimbursement is sought. The healthcare services being initiated by a single healthcare service provider for a single patient. Thereafter, score variables from the variables of the healthcare insurance claims are generated. Based on these score variables, it is determined whether a presence of one or more of the variables in more than one of the healthcare insurance claims is indicative of fraud or error based on levels of co-occurrence of the one or more pairs of variables in historical healthcare insurance claims being initiated by a single healthcare service provider. Subsequently, notification that the one or more of the healthcare insurance claims are indicative of fraud based on a positive determination is initiated (to allow, for example, a user to manually review the healthcare insurance claims, etc.). Related techniques, apparatus, systems, and articles are also described.

### TECHNICAL FIELD

The subject matter described herein relates to techniques for detecting fraud or error in healthcare insurance claims using pairwise co-occurrence, either within or across healthcare insurance claims originating from a single healthcare provider.

### BACKGROUND

When a doctor bills inappropriate codes to an insurance company, there are often inconsistencies in the way their data appears when aggregated. Conventional techniques do not adequately detect these sorts of inconsistencies.

Medicare and Medicaid often have special reimbursement rates for a group of procedures commonly done together, such as typical blood test panels by clinical laboratories. Some health care providers seeking to increase profits will “unbundle” the tests and bill separately for each component of the group, which totals more than the special reimbursement rates. For example, a hospital may bill for each surgical procedure separately to increase the bill amount against billing globally for the surgery as warranted by the law. Alternatively, a provider may add a code to every bill it submits in order to increase reimbursement. If this procedure did not actually occur, this is billing for services not rendered, and would be considered fraud.

Conventional techniques for detecting provider-based fraud, such as unbundling or billing for services not rendered, are mostly rules-based, the rules for which are created manually. One significant disadvantage of the manual intervention is the trouble involved in recreating the rules whenever there is a change in the coding scheme. It is a time intensive process requiring effort of someone with skills and knowledge of the medical coding system, and once the effort has been put forth to create the rules, they are fixed.

### SUMMARY

The current subject matters allows for data analysis on medical claim data to single out providers who engage in performing procedures that are uncalled for, or who systematically bill for services that have not been rendered. In particular, the current subject matter identifies providers which have an unusually high tendency (when compared to population and providers of his specialty) of performing a pair of procedures together (potentially when one of them was unnecessary) on the same patient on the same day. For example, the analysis would catch physicians who tend to conduct more laboratory tests than warranted, or who bill for those laboratory tests in an unconventional fashion by unbundling sets of procedures.

In one aspect, data characterizing one or more healthcare insurance claims is received in which each claim comprises variables characterizing aspects of a healthcare service for which reimbursement is sought and the healthcare services is initiated by a single healthcare service provider for a single patient. Thereafter, score variables are generated from the variables of the healthcare insurance claims. Based on these score variables, it can be determined whether a presence of one or more of the variables in one or more of the healthcare insurance claims is indicative of fraud or error based on levels of co-occurrence of the one or more pairs of variables in historical healthcare insurance claims being initiated by a single healthcare service provider. Thereafter, notification that the one or more of the healthcare insurance claims are indicative of fraud based on a positive determination can be initiated.

There are additional variations which can be implemented in combination or individually. For example, the pairs of variables can be disjoint. The notification can identify which pairs of variables are indicative of fraud or error. A level of unusualness for historical pairs of variables can be determined. The level of unusualness can, for example, be determined by dividing a probability of both variables within a pair being present in the historical healthcare insurance claims by a square root of a product of a probability of a first variable within the pair being present in the historical healthcare insurance claims and a probability of a second variable within the pair being present in the historical healthcare insurance claims. The one or more healthcare insurance claims can be associated with an entity level such that the historical healthcare insurance claims are limited to that associated entity level.

In an interrelated aspect, data characterizing one or more healthcare insurance claims is received in which the claims each include variables characterizing aspects of one of several healthcare services initiated by a single healthcare service provider for which reimbursement is sought. First score variables are generated from the variables of the healthcare insurance claims at a first entity level. It is then first determined whether a presence of one or more of the first pairs of variables in data associated with one or more of the healthcare insurance claims is indicative of fraud or error based on levels of co-occurrence of the one or more first pairs in historical healthcare insurance claims. Second score variables are generated from the variables of the healthcare insurance claims at a second entity level if the first determination is positive. It is second determined whether a presence of one or more of the second pairs of variables in data associated with one or more of the healthcare insurance claims is indicative of fraud or error based on levels of co-occurrence of the one or more second pairs in historical healthcare insurance claims. Notification that the one or more of the healthcare insurance claims is indicative of fraud is initiated if the second determining is positive.

Articles (e.g., computer program products, etc.) are also described that comprise a machine-readable medium embodying instructions that when performed by one or more machines result in operations described herein. Similarly, computer systems are also described that may include a processor and a memory coupled to the processor. The memory may encode one or more programs that cause the processor to perform one or more of the operations described herein.

The subject matter described herein provides many advantages. For example, using the current techniques fraudulent claims can be identified before they are paid. Claims can be scored using limited information that can be readily accessed, quickly processed, and easily reviewed. The technique is adaptive, changing as the historical data and practice patterns change, providing a substantial advantage over a set of rules. Because payors process a large volume of claims, the current techniques are advantageous in that they allow claim adjusters to make quick decisions about the status of a potentially fraudulent claim. Such an arrangement can help minimize the number of possible fraudulent or erroneous claims for an adjuster to review (i.e., false positives suggestive of fraud are reduced). Moreover, by adopting a data driven techniques as opposed to rules-based techniques, historical data is used to quickly and automatically learn.

The details of one or more variations of the subject matter described herein are set forth in the accompanying drawings and the description below. Other features and advantages of the subject matter described herein will be apparent from the description and drawings, and from the claims thereby avoiding the need to manually define rules.

### DESCRIPTION OF DRAWINGS

FIG. 1 is a process flow diagram illustrating a technique for healthcare provider insurance claim fraud and error detection; and

FIG. 2 is a diagram illustrating entities having varying granularities.

### DETAILED DESCRIPTION

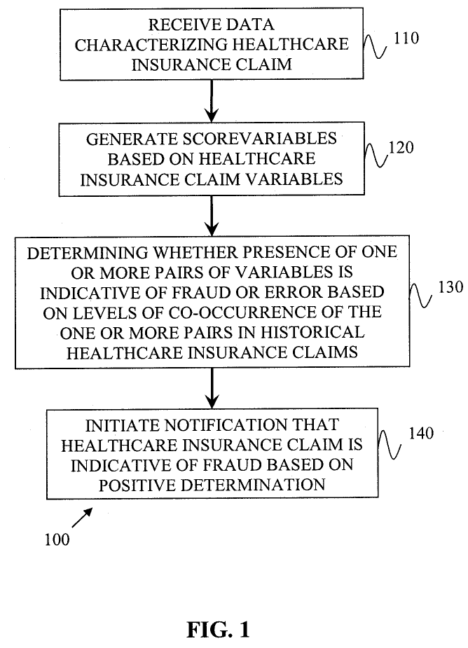

FIG. 1 is a process flow diagram illustrating a method 100, in which, at 110, data characterizing one or more healthcare insurance claims is received. Each claim comprises variables characterizing aspects of a healthcare service for which reimbursement is sought. The healthcare services being initiated by a single healthcare service provider for a single patient. Thereafter, at 120, score variables from the variables of the healthcare insurance claims are generated. Based on these score variables, at 130, it is determined whether a presence of one or more of the variables in more than one of the healthcare insurance claims is indicative of fraud or error based on levels of co-occurrence of the one or more pairs of variables in historical healthcare insurance claims being initiated by a single healthcare service provider. Subsequently, at 140, notification that the one or more of the healthcare insurance claims are indicative of fraud based on a positive determination is initiated (to allow, for example, a user to manually review the healthcare insurance claims, etc.).

The subject matter described herein provides methods and systems for scoring healthcare insurance claims prior to payment, and presenting them to adjusters for review. A healthcare claim can contain many items, including information such as the initiating healthcare service provider (which could be an individual doctor or a larger health organization such as a group of doctors or a hospital or clinic), the procedure being performed, the diagnosis code, where the service was performed, and the type of service performed. All of these elements are categorical; these elements have no inherent ordering, and no inherent value attached to them. Some of these elements have hierarchies as well. Procedure codes, for example, can be grouped into categories with similar procedure codes. There can be one or more levels to these hierarchies. All of these items are referred to herein as variables.

Inconsistent healthcare insurance claims for a single patient originating from a single healthcare service provider can be identified by analyzing an inconsistency score based on one or more of these categorical variables. Consistency (or inconsistency) can be based on co-occurrence (or lack thereof). Statistical analysis of historical healthcare insurance claims data (grouped together by healthcare service provider) can be used to reveal how common it is for a set of services originating from a single healthcare service provide (as represented by variables) to co-occur on a given client.

Patterns within historical data can be used to determine unusualness. Unusualness can be determined entirely from the data, and requires no clinical knowledge or human intervention (in contrast to a rules-based approach for determining consistency).

Variables at any level of the hierarchy (in the case of hierarchical codes) can be compared with variables at any other level in the hierarchy. For example, if the group of codes that represent X-rays (a large set of actual procedure codes) rarely co-occurs with the group of diagnoses that represent skin conditions, entities where these outcomes co-occur will be identified for review.

There are several methods for computing which pairs of variables are least likely to co-occur in the absence of error or fraud. Such methods can revolve around the concept of comparing the historical co-occurrence and gauging how commonly that pair has occurred in the past, relative to how often one would expect it to occur.

One form of an equation to identify unusualness is as follows:

$$u = \frac{P ( α , β )}{\sqrt{P ( α ) P ( β )}}$$

where
u=unusualness
P=probability
α=outcome of categorical variable1
β=outcome of categorical variable 2

In the above equation, unusualness is determined by dividing the probability of observing variables α and β together (based on historical data) by the square root of the product of the probability of observing variables α and β independently (based on historical data). Smoothing factors can be applied to ensure that there are enough observations of both α and β that the results are stable. This can be addressed by using a smoothing mechanism when computing the probabilities in the above formula.

As illustrated in Tables 1-4, various techniques can be used to look at unusualness. The basic idea always involves identifying the likelihood of a pair in the historical data, and highlighting pairs that are unlikely.

TABLE 1

| Name | Formula |
|---|---|
| Support | P(α, β) |
| Piatestsky- | P(α, β) − P(α)P(β) |
| Shapiro | |
| Interest | $\frac{P ( α , β )}{P ( α ) P ( β )}$ |
| Pointwise MI | $max \{ 0 , log [ \frac{P ( α , β )}{P ( α ) P ( β )} ] \}$ |
| Cosine | $\frac{P ( α , β )}{\sqrt{P ( α ) P ( β )}}$ |
| Jaccard | $\frac{P ( α , β )}{P ( α ) + P ( β ) - P ( α , β )}$ |
| Phi-Coeff. | $\frac{P ( α , β ) - P ( α ) P ( β )}{\sqrt{P ( α ) P ( β ) P ( \overline{α} ) ) P ( \overline{β} )}}$ |

TABLE 2

| Name | Formula |
|---|---|
| Confidence | max{P(α\|β), P(β\|α)} |
| Added Value | max{P(β\|α) − P(β), P(α\|β) − P(α)} |
| Klosgen | \sqrt{P(α, β)} max{P(β\|α) − P(β), P(α\|β) − P(α)} |
| Certainty Factor | $max \{ \frac{P ( β \text{\textbar} α ) - P ( β )}{1 - P ( β )} , \frac{P ( α \text{\textbar} β ) - P ( α )}{1 - P ( α )} \}$ |
| Laplace | $max \{ \frac{CP ( α , β ) + 1}{CP ( α ) + 2} , \frac{CP ( α , β ) + 1}{CP ( β ) + 2} \}$ |
| Conviction | $max \{ \frac{P ( α ) P ( \overline{β} )}{P ( α , \overline{β} )} , \frac{P ( \overline{α} ) P ( β )}{P ( \overline{α} , β )} \}$ |

TABLE 3

| Name | Formula |
|---|---|
| Odds-Ratio | $o = \frac{P ( α , β ) P ( \overline{α} , \overline{β} )}{P ( α , \overline{β} ) P ( \overline{α} , β )}$ |
| Yule's Q | $\frac{o - 1}{o + 1} = \frac{P ( α , β ) P ( \overline{α} , \overline{β} ) - P ( α , \overline{β} ) P ( \overline{α} , β )}{P ( α , β ) P ( \overline{α} , \overline{β} ) + P ( α , \overline{β} ) P ( \overline{α} , β )}$ |
| Yule's Y | $\frac{\sqrt{o} - 1}{\sqrt{o} + 1} = \frac{\sqrt{P ( α , β ) P ( \overline{α} , \overline{β} )} - \sqrt{P ( α , \overline{β} ) P ( \overline{α} , β )}}{\sqrt{P ( α , β ) P ( \overline{α} , \overline{β} )} + \sqrt{P ( α , \overline{β} ) P ( \overline{α} , β )}}$ |
| Kappa | $\frac{P ( α , β ) + P ( \overline{α} , \overline{β} ) - P ( α ) P ( \overline{β} ) - P ( \overline{α} ) P ( β )}{1 - P ( α ) P ( β ) - P ( \overline{α} ) P ( \overline{β} )}$ |
| Collective Strength | $[ \frac{P ( α , β ) + P ( \overline{α} , \overline{β} )}{P ( α ) P ( β ) + P ( \overline{α} ) P ( \overline{β} )} ] \times [ \frac{1 - P ( α ) P ( β ) - P ( \overline{α} ) P ( \overline{β} )}{1 - P ( α , β ) - P ( \overline{α} , \overline{β} )} ]$ |

TABLE 4

| Name | Formula |
|---|---|
| Mutual- information | $\frac{I ( α , β )}{min \{ H ( α ) , H ( β ) \}} \begin{matrix}I ( α , β ) = {\sum }_{a ∈ \{ α , \overline{α} \}} {\sum }_{b ∈ \{ β , \overline{β} \}} P ( a , b ) log \frac{P ( a , b )}{P ( a ) P ( b )} \\ H ( α ) = - {\sum }_{a ∈ \{ α , \overline{α} \}} P ( a ) log P ( a )\end{matrix}$ |
| J-Measure | $max \{ \begin{matrix}P ( α , β ) log \frac{P ( α \text{\textbar} β )}{P ( α )} + P ( \overline{α} , β ) log \frac{P ( \overline{α} \text{\textbar} β )}{P ( \overline{α} )} \\ P ( α , β ) log \frac{P ( β \text{\textbar} α )}{P ( β )} + P ( α , \overline{β} ) log \frac{P ( \overline{β} \text{\textbar} α )}{P ( \overline{β} )}\end{matrix} \}$ |
| Gini Index | $max \{ \begin{matrix}\begin{matrix}\begin{matrix}P ( α ) [ {P ( β \text{\textbar} α )}^{2} + {P ( \overline{β} \text{\textbar} α )}^{2} ] + P ( \overline{α} ) [ {P ( β \text{\textbar} \overline{α} )}^{2} + \\ P {( \overline{β} \text{\textbar} \overline{α} )}^{2} ] - {P ( β )}^{2} - {P ( \overline{β} )}^{2}\end{matrix} \\ P ( β ) [ {P ( α \text{\textbar} β )}^{2} + {P ( \overline{α} \text{\textbar} β )}^{2} ] + P ( \overline{β} ) [ {P ( α \text{\textbar} \overline{β} )}^{2} +\end{matrix} \\ P {( \overline{α} \text{\textbar} \overline{β} )}^{2} ] - {P ( α )}^{2} - {P ( \overline{α} )}^{2}\end{matrix} \}$ |
| Goodman- Kruskal | $\frac{\begin{matrix}{\sum }_{a ∈ \{ α , \overline{α} \}} {max}_{b ∈ \{ β , \overline{β} )} P ( a , b ) + {\sum }_{b ∈ \{ β , \overline{β} \}} {max}_{a ∈ \{ α , \overline{α} \}} P ( a , b ) - \\ {max}_{a ∈ \{ α , \overline{α} \}} P ( a ) - {max}_{b ∈ \{ β , \overline{β} )} P ( b )\end{matrix}}{2 - {max}_{a ∈ \{ α , \overline{α} \}} P ( a ) - {max}_{b ∈ \{ β , \overline{β} )} P ( b )}$ |

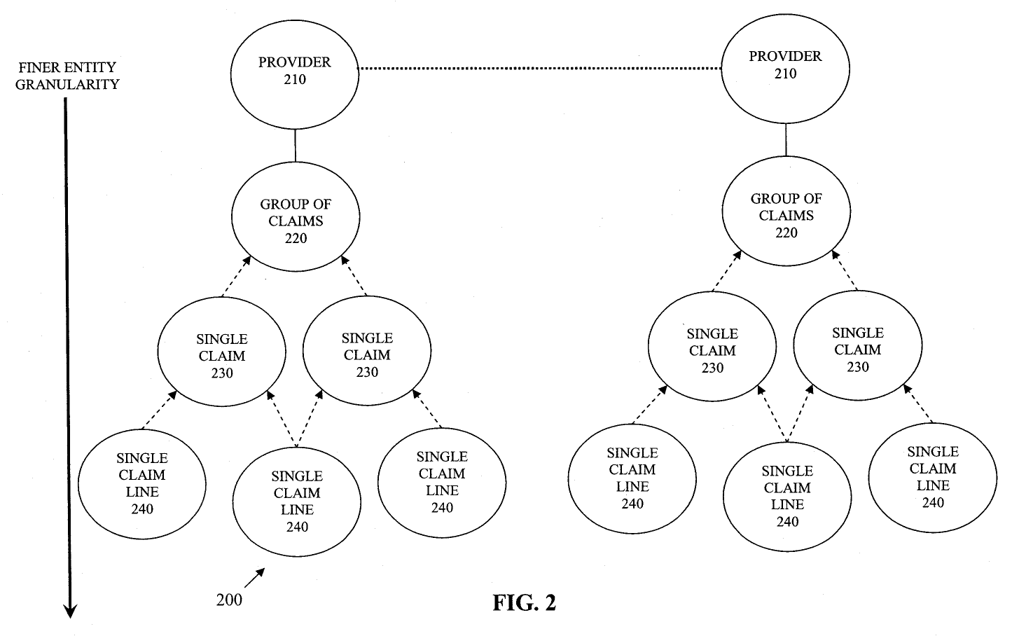

Consistency can be determined at some “entity” level. FIG. 2 is a diagram 200 illustrating various entity levels which may be considered in determining whether a healthcare insurance claim is indicative of fraud or error. In this example, for a provider 210, a coarsest granularity of an entity might comprise a group of claims 220, with finer granularities based on a single claim 230 (as a whole), or a single line in a claim 240. As one example, procedure codes and diagnosis codes (which are also referred to as variables) on a claim line can be scored for inconsistency. An entity could also include an entire healthcare insurance claim (a collection of lines), a patient, or several patients receiving care initiated by a single healthcare service provider.

When one or more healthcare insurance claims are received, they can each be associated with a particular entity level which is in turn used to determine the scope of the historical data for which the co-occurrence probability analysis is conducted. In some implementations, the co-occurrence analysis can be conducted at a first entity level, and if such entity level indicates fraud or error, then the analysis can be conducted a second time at a second entity level (which may require the generation of new score variables). The first entity level might include, for example, a single line of a claim while the second entity level might include all of the lines of the claim. Similarly, the first entity level might include, for example, a group of claims originating from a single healthcare facility on a particular day for a particular patient, and the second entity level might include a group of claims from that same healthcare facility and patient but over a longer time period (e.g., week, month, year, etc.).

It is critical in prepayment claim review that the results of a score are immediately actionable. Since a large number of claims are reviewed each day, a decision must be made and acted upon immediately. This type of approach is designed to be easily reviewable and immediately actionable. Notification can include a summary of information relevant to healthcare insurance claims that is presented in an easy to understand format for a claims reviewer. The relevant outcomes for α and β can easily be displayed, and a reviewer can come to a conclusion about the claim and/or subject it to further analysis at a different entity granularity level.

Additional features of the claims can also taken into account in the score, and may be compared with historical norms. For example, if the procedure code and place of service (POS) are found to be mismatched, a reviewer may be more interested in this mismatch if the erroneous POS results in higher reimbursement. These features are incorporated into the score, and can be presented to the reviewer to make fraud more apparent.

The report identifies providers which have an unusually high tendency (when compared to population and providers of his specialty) of performing a pair of procedures together (which potentially should have bundled for purposes of insurance claims) on the same patient on the same day.

In some implementations, for a pair of procedures (e.g., p1 and p2), the probability of a provider performing p1 given p2 was performed and probability of performing p2 given that p1 was performed can be calculated. Thereafter, similar statistics can be computed for every provider and the population. The providers who have an unusually high probability of performing a procedure given another particular procedure that was performed relative to his peers will generate a high score. The “Provider-Procedure pair” results as described above can then be rolled up to the provider level to identify provider who indulge in such practices regularly and potentially intentionally (and can thus, for example, be flagged for more frequent manual review).

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. In addition, it will be appreciated that the techniques used herein may be used in connection with other non-healthcare claims or data structures in which variables may be extracted in order to determine whether such claim or data structure is atypical and requires additional review or analysis. Other embodiments may be within the scope of the following claims.

What is claimed is:

1. An article comprising a tangible machine-readable storage medium embodying instructions that when performed by one or more machines result in operations comprising:
receiving data characterizing one or more healthcare insurance claims, each claim comprising variables characterizing aspects of a healthcare service for which reimbursement is sought, the healthcare services being initiated by a single healthcare service provider for a single patient;
generating score variables from the variables of the healthcare insurance claims;
determining whether a presence of one or more of the variables in one or more of the healthcare insurance claims is indicative of fraud or error based on levels of co-occurrence of the one or more pairs of variables in historical healthcare insurance claims being initiated by a single healthcare service provider; and
initiating notification that the one or more of the healthcare insurance claims are indicative of fraud based on a positive determination.

2. An article as in claim 1, wherein the pairs of variables are disjoint.

3. An article as in claim 1, wherein the notification identifies which pairs of variables are indicative of fraud or error.

4. An article as in claim 1, wherein the article embodies instructions that when performed by one or more machines result in further operations comprising:
determining a level of unusualness for historical pairs of variables.

5. An article as in claim 4, wherein the level of unusualness is determined by dividing a probability of both variables within a pair being present in the historical healthcare insurance claims by a square root of a product of a probability of a first variable within the pair being present in the historical healthcare insurance claims and a probability of a second variable within the pair being present in the historical healthcare insurance claims.

6. An article as in claim 1, wherein the article embodies instructions that when performed by one or more machines result in further operations comprising:
associating the one or more healthcare insurance claims with an entity level; and
wherein the historical healthcare insurance claims are limited to the associated entity level.

7. A computer-implemented method for performance by execution of computer readable program code by a processor of one or more computer systems, the method comprising:
receiving data characterizing one or more healthcare insurance claims, each claim comprising variables characterizing aspects of a healthcare service for which reimbursement is sought, the healthcare services being initiated by a single healthcare service provider for a single patient;
generating score variables from the variables of the healthcare insurance claims;
determining whether a presence of one or more of the variables in more than one of the healthcare insurance claims is indicative of fraud or error based on levels of co-occurrence of the one or more pairs of variables in historical healthcare insurance claims being initiated by a single healthcare service provider; and
initiating notification that the one or more of the healthcare insurance claims are indicative of fraud based on a positive determination.

8. A method as in claim 7, wherein the pairs of variables are disjoint.

9. A method as in claim 7, wherein the notification identifies which pairs of variables are indicative of fraud or error.

10. A method as in claim 7, further comprising:
determining a level of unusualness for historical pairs of variables.

11. A method as in claim 10, wherein the level of unusualness is determined by dividing a probability of both variables within a pair being present in the historical healthcare insurance claims by a square root of a product of a probability of a first variable within the pair being present in the historical healthcare insurance claims and a probability of a second variable within the pair being present in the historical healthcare insurance claims.

12. A method as in claim 7, further comprising:
associating the one or more healthcare insurance claims with an entity level; and
wherein the historical healthcare insurance claims are limited to the associated entity level.

13. An article comprising a tangible machine-readable storage medium embodying instructions that when performed by one or more machines result in operations comprising:
receiving data characterizing one or more healthcare insurance claims, the claims each comprising variables characterizing aspects of one of several healthcare services initiated by a single healthcare service provider for which reimbursement is sought;
generating first score variables from the variables of the healthcare insurance claims at a first entity level;
first determining whether a presence of one or more of the first pairs of variables in data associated with one or more of the healthcare insurance claims is indicative of fraud or error based on levels of co-occurrence of the one or more first pairs in historical healthcare insurance claims;
generating second score variables from the variables of the healthcare insurance claims at a second entity level if the first determining is positive;
second determining whether a presence of one or more of the second pairs of variables in data associated with one or more of the healthcare insurance claims is indicative of fraud or error based on levels of co-occurrence of the one or more second pairs in historical healthcare insurance claims; and
initiating notification that the one or more of the healthcare insurance claims is indicative of fraud if the second determining is positive.

14. An article as in claim 13, wherein a granularity of the first entity level is greater than a granularity of the second entity level.

15. An article as in claim 13, wherein a granularity of the second entity level is greater than a granularity of the first entity level.

16. An article as in claim 13, wherein the first pairs of variables and the second pairs of variables are disjoint.

17. An article as in claim 13, wherein the notification identifies which pairs of variables are indicative of fraud or error.

18. An article as in claim 13, wherein the article embodies instructions that when performed by one or more machines result in further operations comprising:
determining a level of unusualness for historical pairs of variables.

19. An article as in claim 18, wherein the level of unusualness is determined by dividing a probability of both variables within a pair being present in the historical data by a square root of a product of a probability of a first variable within the pair being present in the historical data and a probability of a second variable within the pair being present in the historical data.

20. An article as in claim 13, wherein the article embodies instructions that when performed by one or more machines result in further operations comprising:
associating generated of variables for the healthcare insurance claim with an associated entity level; and
wherein the historical healthcare insurance claims are limited to the corresponding associated entity level.
